(19) United States
(12) Patent Application Publication
(10) Pub. No.: US 2026/0067046 A1
(43) Pub. Date: Mar. 5, 2026

(54) PHASE SHIFTED SRS AND PUSCH TRANSMISSION ACROSS PRB

(71) Applicant: Telefonaktiebolaget LM Ericsson (publ), Stockholm (SE)

(72) Inventors: Yueyu WANG, Karlstad (SE); Ming LI, Stockholm (SE)

(73) Assignee: Telefonaktiebolaget LM Ericsson (publ), Stockholm (SE)

(21) Appl. No.: 19/104,402

(22) PCT Filed: Aug. 31, 2022
(86) PCT No.: PCT/EP2022/074258

§ 371 Date: Feb. 18, 2025

(51) Int. Cl. H04L 5/00

(52) U.S. Cl. CPC H04L 5/0051; H04L 5/0044

(57) ABSTRACT

A method performed by a user equipment (UE) is provided. The method includes receiving from a network node, a sounding reference signal (SRS) configuration. The method further includes transmitting an uplink transmission towards the network node including a SRS across a first physical resource block (PRB) and a phase shifted SRS across at least one additional PRB. A UE and related methods and apparatus are also disclosed.

### TECHNICAL FIELD

The present disclosure relates generally to a method for phase shifted sounding reference signal (SRS) and/or physical uplink shared channel (PUSCH) transmission across a physical resource block (PRB), and related apparatuses and methods.

### BACKGROUND

A fifth generation (5G) system can introduce massive multiple-input multiple-output (MIMO) with beam forming, which can allow the 5G network to send a specific beam of data to a user equipment (UE). This procedure may decrease inter-user interference and may improve system performance, e.g., particularly with a narrow beam, for example. When a UE is moving, however, it may cause a beam failure.

### SUMMARY

A method performed by a UE is provided. The method includes receiving, from a network node, a SRS configuration; and transmitting an uplink transmission towards the network node comprising a SRS across a first PRB and a phase shifted SRS across at least one additional PRB.

A method performed by a network node is provided. The method includes transmitting, to a UE a SRS configuration; and receiving from the UE a SRS transmitted across a first PRB and a phase shifted SRS transmitted across at least one additional PRB.

A method performed by a network node is provided. The method includes detecting a channel status based on a SRS received from a UE; and transmitting, to the UE, one of a trigger or a configuration for a phase shifted PUSCH transmission across at least one PRB for the UE based on the detected channel status.

A method performed by a UE is provided. The method includes receiving, from a network node, one of a trigger or a configuration for a phase shifted PUSCH transmission across at least one PRB for the UE based on the detected channel status; and transmitting, to the network node, the phase shifted PUSCH transmission across the at least one PRB.

A UE is provided. The UE includes processing circuitry. The UE further includes memory coupled with the processing circuitry. The memory includes instructions that when executed by the processing circuitry causes the UE to perform operations. The operations include to receive, from a network node, a SRS configuration; and to transmit an uplink transmission towards the network node including a SRS across a first PRB and a phase shifted SRS across at least one additional PRB.

A UE is provided that is adapted to perform operations. The operations include to receive, from a network node, a SRS configuration; and to transmit an uplink transmission towards the network node including a SRS across a first PRB and a phase shifted SRS across at least one additional PRB.

A computer program including program code to be executed by processing circuitry of a UE is provided. Execution of the program code causes the UE to perform operations. The operations include to receive, from a network node, a SRS configuration; and to transmit an uplink transmission towards the network node including a SRS across a first PRB and a phase shifted SRS across at least one additional PRB.

A computer program product including a non-transitory storage medium including program code to be executed by processing circuitry of a UE is provided. Execution of the program code causes the UE to perform operations. The operations include to receive, from a network node, a SRS configuration; and to transmit an uplink transmission towards the network node including a SRS across a first PRB and a phase shifted SRS across at least one additional PRB.

A network node is provided. The network node includes processing circuitry. The network node further includes memory coupled with the processing circuitry. The memory includes instructions that when executed by the processing circuitry causes the network node to perform operations. The operations include to transmit, to a UE, a SRS configuration; and to receive from the UE a SRS transmitted across a first PRB and a phase shifted SRS transmitted across at least one additional PRB.

A network node is provided that is adapted to perform operations. The operations include to transmit, to a UE, a SRS configuration; and to receive from the UE a SRS transmitted across a first PRB and a phase shifted SRS transmitted across at least one additional PRB.

A computer program including program code to be executed by processing circuitry of a network node is provided. Execution of the program code causes the network node to perform operations. The operations include to transmit, to a UE, a SRS configuration; and to receive from the UE a SRS transmitted across a first PRB and a phase shifted SRS transmitted across at least one additional PRB.

A computer program product including a non-transitory storage medium including program code to be executed by processing circuitry of a network node is provided. Execution of the program code causes the network node to perform operations. The operations include to transmit, to a UE, a SRS configuration; and to receive from the UE a SRS transmitted across a first PRB and a phase shifted SRS transmitted across at least one additional PRB.

A network node is provided. The network node includes processing circuitry. The network node further includes memory coupled with the processing circuitry. The memory includes instructions that when executed by the processing circuitry causes the network node to perform operations. The operations include to detect a channel status based on a SRS received from a UE; and transmit, to the UE, one of a trigger or a configuration for a phase shifted PUSCH transmission across at least one PRB for the UE based on the detected channel status.

A network node is provided that is adapted to perform operations. The operations include to detect a channel status based on a SRS received from a UE; and transmit, to the UE, one of a trigger or a configuration for a phase shifted PUSCH transmission across at least one PRB for the UE based on the detected channel status.

A computer program including program code to be executed by processing circuitry of a network node is provided. Execution of the program code causes the network node to perform operations. The operations include to detect a channel status based on a SRS received from a UE; and transmit, to the UE, one of a trigger or a configuration for a phase shifted PUSCH transmission across at least one PRB for the UE based on the detected channel status.

A computer program product including a non-transitory storage medium including program code to be executed by processing circuitry of a network node is provided. Execution of the program code causes the network node to perform operations. The operations include to detect a channel status based on a SRS received from a UE; and transmit, to the UE, one of a trigger or a configuration for a phase shifted PUSCH transmission across at least one PRB for the UE based on the detected channel status.

A UE is provided. The UE includes processing circuitry. The UE further includes memory coupled with the processing circuitry. The memory includes instructions that when executed by the processing circuitry causes the UE to perform operations. The operations include to receive, from a network node, one of a trigger or a configuration for a phase shifted PUSCH transmission across at least one PRB for the UE based on the detected channel status; and to transmit, to the network node, the phase shifted PUSCH transmission across the at least one PRB.

A UE is provided that is adapted to perform operations. The operations include to receive, from a network node, one of a trigger or a configuration for a phase shifted PUSCH transmission across at least one PRB for the UE based on the detected channel status; and to transmit, to the network node, the phase shifted PUSCH transmission across the at least one PRB.

A computer program including program code to be executed by processing circuitry of a UE is provided. Execution of the program code causes the UE to perform operations. The operations include to receive, from a network node, one of a trigger or a configuration for a phase shifted PUSCH transmission across at least one PRB for the UE based on the detected channel status; and to transmit, to the network node, the phase shifted PUSCH transmission across the at least one PRB.

A computer program product including a non-transitory storage medium including program code to be executed by processing circuitry of a UE is provided. Execution of the program code causes the UE to perform operations. The operations include to receive, from a network node, one of a trigger or a configuration for a phase shifted PUSCH transmission across at least one PRB for the UE based on the detected channel status; and to transmit, to the network node, the phase shifted PUSCH transmission across the at least one PRB.

Technical advantages provided by various embodiments of the present disclosure may include that based on inclusion of a transmission that includes a SRS across a first physical resource block (PRB), and a phase shifted SRS or PUSCH across at least one additional PRB, spatial diversity gain across a PRB(s) for SRS and/or PUSCH transmission may be provided. Moreover, robustness of uplink (UL) transmitting may be increased; and/or beam failure rate, beam failure recovery, or a hybrid automatic repeat request (HARQ) rate may be decreased.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating interference and blocking of a UE beam;

FIG. 2 is a schematic diagram of phase shifted SRS transmission across a PRB(s) in accordance with some embodiments of the present disclosure;

FIG. 3 is a signalling diagram illustrating another example embodiment of SRS phase shifted transmission;

FIG. 4 is a signalling diagram illustrating an embodiment of phase shifted SRS transmission across PRB(s) triggered by a UE;

FIG. 5 is a signalling diagram illustrating an example embodiment of PUSCH phase shifted transmission across PRB(s);

FIG. 6 is a schematic diagram illustrating an example embodiment of resource mapping before and after interleaving;

FIG. 7 is a flow chart illustrating operations of a UE according to some embodiments of the present disclosure;

FIG. 8 is a flow chart illustrating operations of a network node according to some embodiments of the present disclosure;

FIG. 9 is a flow chart illustrating operations of a network node according to some embodiments of the present disclosure;

FIG. 10 is a flow chart illustrating operations of a UE according to some embodiments of the present disclosure;

FIG. 11 is a block diagram of a communication system in accordance with some embodiments;

FIG. 12 is a block diagram of a user equipment in accordance with some embodiments;

FIG. 13 is a block diagram of a network node in accordance with some embodiments;

FIG. 14 is a block diagram of a host computer communicating with a user equipment in accordance with some embodiments;

FIG. 15 is a block diagram of a virtualization environment in accordance with some embodiments; and

FIG. 16 is a block diagram of a host computer communicating via a base station with a user equipment over a partially wireless connection in accordance with some embodiments in accordance with some embodiments.

### DETAILED DESCRIPTION

The present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The following explanation of potential problems with some approaches is a present realization as part of the present disclosure and is not to be construed as previously known by others.

As previously referenced, when a UE is moving (e.g., out of a 3 dB beamwidth), beam failure can occur. In some frequency ranges, for example, interference or blocking of a beam between by objects between a network node and the UE may occur. The interference or blocking can break a link between the network node and the UE and cause beam failure.

In a massive MIMO scenario, for example, a UE specific beam can be narrower than in other scenarios, which can result in the beam being easily twisted or blocked.

Interference or blocking of the beam can increase a rate of HARQ, and can result in beam failure. Interference, blocking, and/or beam failure can be particularly problematic at high band (HB) frequencies, for example.

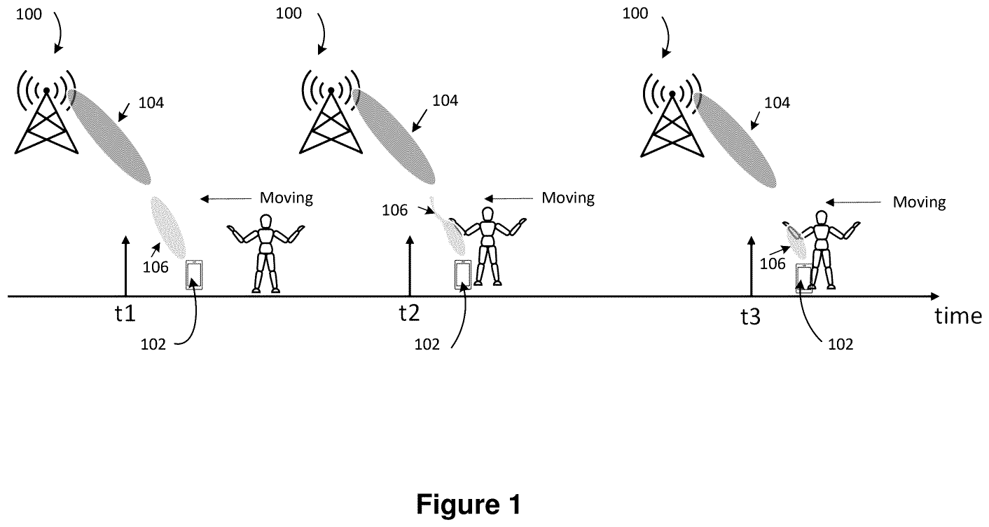

FIG. 1 is a schematic diagram illustrating interference and blocking of a UE beam. At time t1, a link based on a receive beam 104 and a narrow UE beam 106 is setup between a network node 100 (e.g., a gNodeB (gNB)) and UE 102. At time t2, as shown in FIG. 1, the beam link 106 is distorted due to UE 102 mobility or other moving objects (such as the illustrated person). At time t3, the beam link 106 may be completely blocked. At t2 and t3, it may be possible to trigger an UL HARQ or beam failure recovery, particularly at HB for example. While Third Generation Partnership Project (3GPP) may include a method about beam failure and recovery, 3GPP lacks operations on how to avoid beam failure.

Embodiments of the present disclosure may provide solutions to these and other potential problems. Some embodiments of the present disclosure provide operations for a network node and a UE that may increase robustness of an uplink (UL) transmission, including in massive MIMO scenarios, for example.

For example, in massive MIMO scenarios, the network indicates and configures SRS phase shift transmitting across PRB(s). An SRS feature can be used to identify both the best UE transmitted beam and the best network node (e.g., gnB/evolved Node B (eNB)) receive beam. In some embodiments of the present disclosure, phase shifted SRS transmission across PRB(s) is supported by a UE. As a consequence, more accurate and reliable transmission may be accomplished.

While certain embodiments are described with reference to a massive MIMO scenario, the present disclosure is not so limited, and includes other scenarios that include multiple or narrow beams (e.g., with other antenna types, etc.).

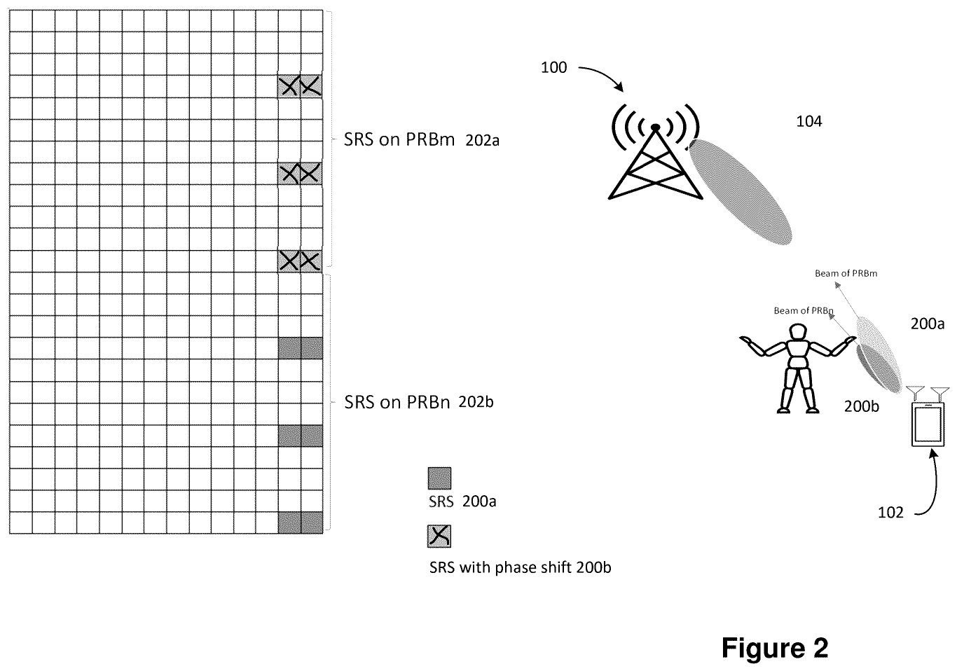

FIG. 2 is a schematic diagram of phase shifted SRS transmission across a PRB(s) in accordance with some embodiments of the present disclosure. PRBn is used to transmit SRS (SRS on PRBn 202b), and PRBm is used to transmit phase shifted SRS (SRS on PRBm 202a). As shown in the example embodiment of FIG. 2, two antennas are co-phase antenna, and two beams are included: beam PRBn 200b, and beam PRBm 200a. Thus, even though beam PRBn 200b is blocked, beam PRBm 200a is still within 3 db beamwidth of the network node 100. It is noted that that while FIG. 2 shows two beams 200a, 200b, the method of the present disclosure is not so limited and there is no restriction on the number of beams. For example, there can be more than three beams according to a configuration of the network node.

In some embodiments, SRS phase shift transmitting is triggered by a UE according to UE capability, and the network node has a capability to detect channel quality based on SRS from different PRB(s).

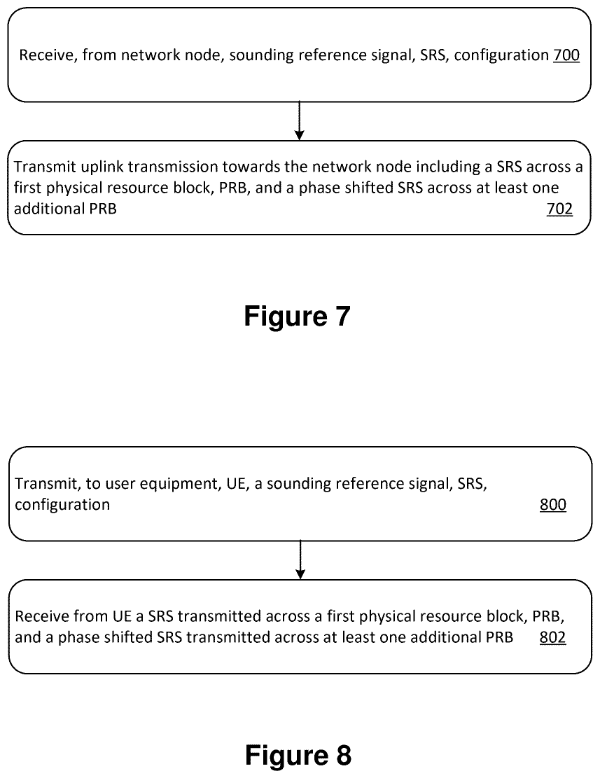

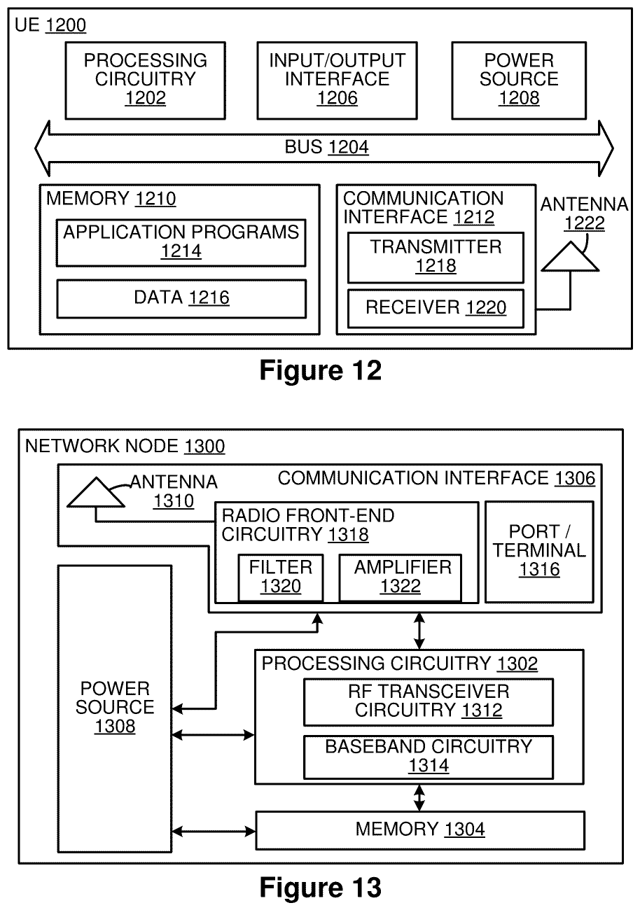

As previously discussed, operations of some embodiments include SRS phase shift transmitting across PRB(s) for uplink transmitting. FIG. 7 is a flowchart of a flow chart illustrating operations of a UE (implemented using the structure of the block diagram of FIG. 12) according to some embodiments of the present disclosure. For example, modules may be stored in memory 1210 of FIG. 12, and these modules may provide instructions so that when the instructions of a module are executed by respective UE processing circuitry 1202, processing circuitry 1202 performs respective operations of the flow chart. A method performed by a UE includes receiving (700), from a network node, a SRS configuration. The method further includes transmitting (702) an UL transmission towards the network node including a SRS across a first PRB and a phase shifted SRS across at least one additional PRB.

The SRS phase shifting can be triggered by a radio resource control (RRC) message or a UE itself. A UE dedicated RRC message can include a field for SRS phase shift transmitting across PRB(s). Downlink control information (DCI) can include support for SRS phase shift transmitting PRB(s). In some embodiments, receiving (700) the SRS configuration includes receiving a RRC message. Some embodiments include that the transmitting (702) the phase shifted SRS across the at least one additional PRB is triggered by the UE.

Operations can include that a UE can perform SRS phase shift transmitting conditionally according to downlink reference signal measurement. In an example embodiment, the transmitting (702) the phase shifted SRS across the at least one additional PRB includes conditionally transmitting the phase shifted SRS according to a downlink reference signal measurement.

In some embodiments, the transmitting (702) the phase shifted SRS across the at least one additional PRB is triggered by the network node. In an example embodiment, the triggering by the network node is triggered by a wireless channel status, or evaluation of a speed or direction of movement of the UE.

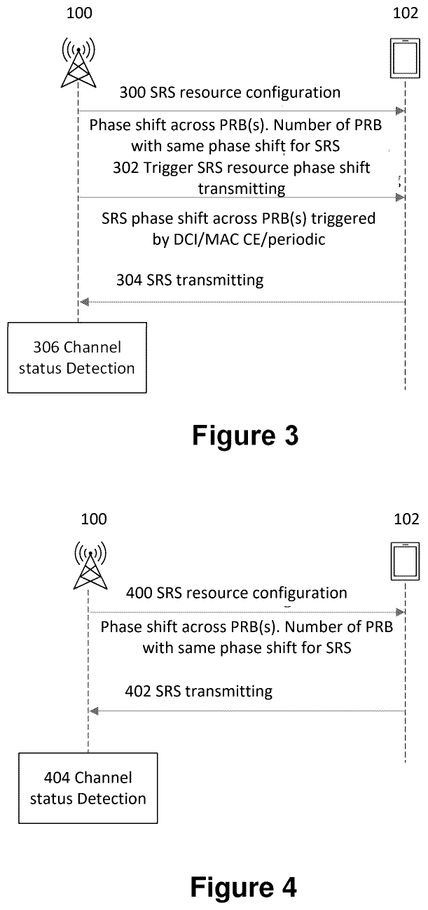

FIG. 3 is a signalling diagram illustrating another example embodiment of SRS phase shifted transmission. In operation 300, network node 100 signals to UE 102 a SRS resource configuration that includes a phase shift across PRB(s) and a number of PRB with the same phase shift for the SRS. In operation 302, network node 100 signals the UE 102 with a trigger for SRS phase shifted transmission of the UE 102. The trigger may include SRS phase shifting across PRB(s) triggered by downlink control information (DCI), a medium access control (MAC) control element (CE), or a periodic transmission set in the configuration. UE 102, in operation 304, signals an SRS transmission to network node 100. In operation 306, network node 100 detects channel status.

The SRS resource configuration can include a RRC message. The RRC message can include a field for phase shifted SRS transmitting across PRB. The field can include a phase shift value, a size of PRB with the same phase shift, or the size of PRB is the same as a PRB size of PRB bundling, etc.

In an example embodiment, the configuration includes at least one of a value for the phase shift, and a size of the at least one additional PRB. The size can include at least one of: a number of PRB having the same phase shift for the SRS, a size that matches a size of the first PRB, or a first indicator that indicates the size, and wherein the value for the phase shift comprises an indicator that indicates the value. The value of the phase shift and the size of PRB can be configured by the network or determined by the UE itself. The size of the PRB can be the same size as a PRB bundling size according to channel reciprocity, or SRS phase shift transmission can combine with PRB bundling.

In some embodiments, full information of the phase shift, and/or a size of PRB is not included, which may help to avoid overhead of the RRC message. Thus, in some embodiments, the field can include a small size index/range to indicate the phase shift and a size of PRB.

Phase shift SRS across a PRB(s) can be set to periodic, triggered by semi-persistent, (e.g., by MAC CE), or aperiodic (e.g., by DCI) according to the network configuration. In some embodiments, the transmitting (702) the phase shifted SRS across the at least one additional PRB includes at least one of: (i) an aperiodic transmission triggered by a DCI, (ii) a semi persistent transmission triggered by MAC CE, and (iii) a periodic transmission set in the configuration.

Alternatively, to help in providing spatial diversity gain across PRB(s), the UE can activate or trigger phase shifted SRS across PRB by itself. FIG. 4 is a signalling diagram illustrating an embodiment of phase shifted SRS transmission across PRB(s) triggered by a UE. In operation 400, network node 100 signals to UE 102 a SRS resource configuration that includes a phase shift across PRB(s) and a number of PRB with the same phase shift for the SRS. In operation 402, UE 102 signals an SRS transmission to network node 100. In operation 404, network node 100 detects channel status. In the example embodiment of FIG. 4, network node 100 has capability to detect a gain provided by the operations.

FIG. 8 is a flowchart of a flow chart illustrating operations of a network node (implemented using the structure of the block diagram of FIG. 13) according to some embodiments of the present disclosure. For example, modules may be stored in memory 1304 of FIG. 13, and these modules may provide instructions so that when the instructions of a module are executed by respective network node processing circuitry 1302, processing circuitry 1302 performs respective operations of the flow chart. A method of the network node includes transmitting (800), to a UE, a SRS configuration; and receiving (802) from the UE a SRS transmitted across a first PRB and a phase shifted SRS transmitted across at least one additional PRB.

The configuration can include at least one of a value for the phase shift, and a size of the at least one additional PRB. The size can include at least one of: a number of PRB having the same phase shift for the SRS, a size that matches a size of the first PRB, or a first indicator that indicates the size, and wherein the value for the phase shift comprises an indicator that indicates the value.

In some embodiments, the transmitting (800) the SRS configuration includes transmitting a RRC message.

The phase shifted SRS transmitted across the at least one additional PRB can be triggered by the UE.

In some embodiments, the phase shifted SRS transmitted across the at least one additional PRB includes a conditionally transmitted phase shifted SRS according to a downlink reference signal measurement.

The phase shifted SRS transmitted across the at least one additional PRB can include at least one of: (i) an aperiodic transmission triggered by a downlink control information, DCI, (ii) a semi persistent transmission triggered by a medium access control, MAC, control element (CE), and (iii) a periodic transmission set in the configuration.

In some embodiments, the phase shifted SRS transmitted across the at least one additional PRB is triggered by the network node. The triggered by the network node can be triggered by a wireless channel status, or an evaluation of a speed or direction of movement of the UE.

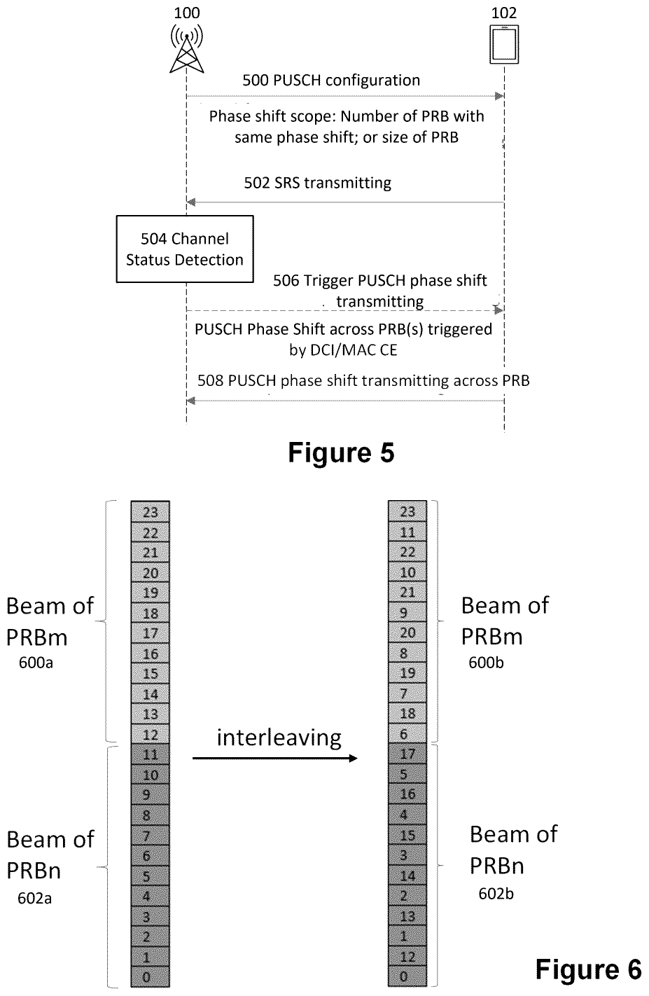

In other embodiments, phase sifted PUSCH transmission across PRB(s) is supported, e.g., to try to obtain spatial gain across PRB(s). For example, according to a detection result of SRS, network node 100 can decide whether to trigger phase shifted PUSCH transmission across PRB(s). FIG. 5 is a signalling diagram illustrating an example embodiment of PUSCH phase shifted transmission across PRB(s). In operation 500, network node 100 signals to UE 102 a PUSCH configuration that includes a phase shift scope that includes a number of PRB with the same phase shift or a size of PRB is the same as a PRB size of PRB bundling. In operation 502, UE 102 signals an SRS transmission to network node 100. In operation 504, network node 100 detects channel status. Network node 100, in operation 506, signals the UE 102 with a trigger for PUSCH phase shifted transmission of the UE 102. The trigger may include PUSCH phase shifting across PRB(s) triggered by DCI, or a MAC CE. UE 102, in operation 508, signals to network node 100 a PUSCH phase shifted transmission across PRB(s).

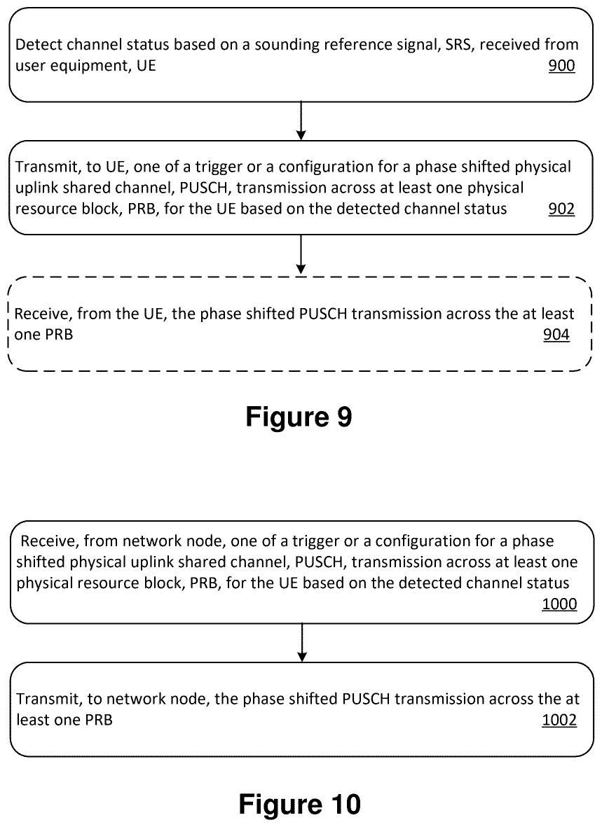

FIG. 9 is a flowchart of a flow chart illustrating operations of a network node (implemented using the structure of the block diagram of FIG. 13) according to some embodiments of the present disclosure. For example, modules may be stored in memory 1304 of FIG. 13, and these modules may provide instructions so that when the instructions of a module are executed by respective network node processing circuitry 1302, processing circuitry 1302 performs respective operations of the flow chart. A method of the network node includes detecting (900) a channel status based on a SRS received from a UE; and transmitting (902), to the UE, one of a trigger or a configuration for a phase shifted PUSCH transmission across at least one PRB for the UE based on the detected channel status. Some embodiments further include receiving (904), from the UE, the phase shifted PUSCH transmission across the at least one PRB. The trigger can include comprises at least one of a DCI, and a MAC CE. Transmitting the configuration can include at least one of a signaling a message and signaling a DCI. The message can include a RRC message.

Various operations from the flow chart of FIG. 9 may be optional with respect to some embodiments of network nodes and related methods. For example, the operations of block 904 of FIG. 9 may be optional.

In some embodiments, the network node can enable/disable PUSCH phase shift transmitting across PRB(s) by RRC message or DCI, according to SRS detection results. In an example embodiment, the RRC message or DCI includes a field to enable/disable PUSCH phase shift transmitting across PRB(s) and value of phase shift.

In some embodiments, according to SRS detection, network node 100 decides whether PUSCH phase shifted transmission across PRB(s) is needed. Network node 100 triggers or schedules PUSCH phase sifted transmission with DCI or a MAC CE. In an example embodiment, the trigger or the configuration, respectively, includes at least one of: an indicator for enabling/disabling the phase shifted PUSCH transmission across the at least one PRB, a value of the phase shift, and a number of the at least one PRB. The number of the at least one PRB can include at least one of a configurable number or a set number (e.g., to the same size as a PRB bundle size).

To try to avoid PRB(s) block fading, in other embodiments, interleaving across PRB(s) of PUSCH bundling with a phase shift across PRB(s) is included according to a network configuration. FIG. 6 is a schematic diagram illustrating an example embodiment of resource mapping before and after interleaving. The interleaving deep and length can be changed or configurable. Thus, when beam PRBm 600a or PRBn 602a, respectively, is blocked, the blocked beam can still be decoded correctly with interleaving technology with channel coding (e.g., Turbo (for Long Term Evolution (LTE)) or low density parity check (LDPC) for NR) into beam PRBm 600b or beam PRBn 602b, respectively. An interleaving table length and deep can be configured by an RRC message or DCI. In an example embodiment, the configuration includes a configurable depth and a configurable length for the interleaving.

In some embodiments, the configuration for the phase shifted PUSCH transmission includes an interleaving of a PUSCH with a phase shift across the at least one PRB.

Interleaving across bundling with PUSCH phase shift can be triggered or configured by network node 100 according to a channel status detection result of SRS. The trigger or configuration can be included in an RRC message or DCI.

The interleaving, in some embodiments, is supported across the at least one PRB within a orthogonal frequency division multiplexing, OFDM, symbol. An RRC message or DCI can include a field for PUSCH interleaving across PRB(s) within the same OFDM symbol.

The UE can support PUSCH phase shift transmitting across PRB(s). FIG. 10 is a flowchart of a flow chart illustrating operations of a UE (implemented using the structure of the block diagram of FIG. 12) according to some embodiments of the present disclosure.

For example, modules may be stored in memory 1210 of FIG. 12, and these modules may provide instructions so that when the instructions of a module are executed by respective UE processing circuitry 1202, processing circuitry 1202 performs respective operations of the flow chart. A method performed by a UE includes receiving (1000), from a network node, one of a trigger or a configuration for a PUSCH transmission across at least one PRB for the UE based on the detected channel status. The method further includes transmitting (1002), to the network node, the phase shifted PUSCH transmission across the at least one PRB.

The trigger can include at least one of a DCI, and a MAC CE. Transmitting the configuration can include at least one of a signaling a message and signaling a DCI. In some embodiments, the message is a RRC message.

The trigger or the configuration, respectively, can include at least one of: an indicator for enabling/disabling the phase shifted PUSCH transmission across the at least one PRB, a value of the phase shift, and a number of the at least one PRB. In some embodiments, the number of the at least one PRB includes at least one of a configurable number or a set number.

The configuration for the phase shifted PUSCH transmission can include an interleaving of a PUSCH with a phase shift across the at least one PRB.

In an example embodiment, the interleaving is supported across the at least one PRB within a OFDM symbol.

The configuration can include a configurable depth and a configurable length for the interleaving.

Further technical advantages provided by various embodiments of the present disclosure that include interleaving across PRB(s) for PUSCH may include resistance block fading within PRB(s) for PUSCH. Moreover, if an UL beam is blocked or distorted in PRB(s), the UL beam may be recovered by other PRB(s).

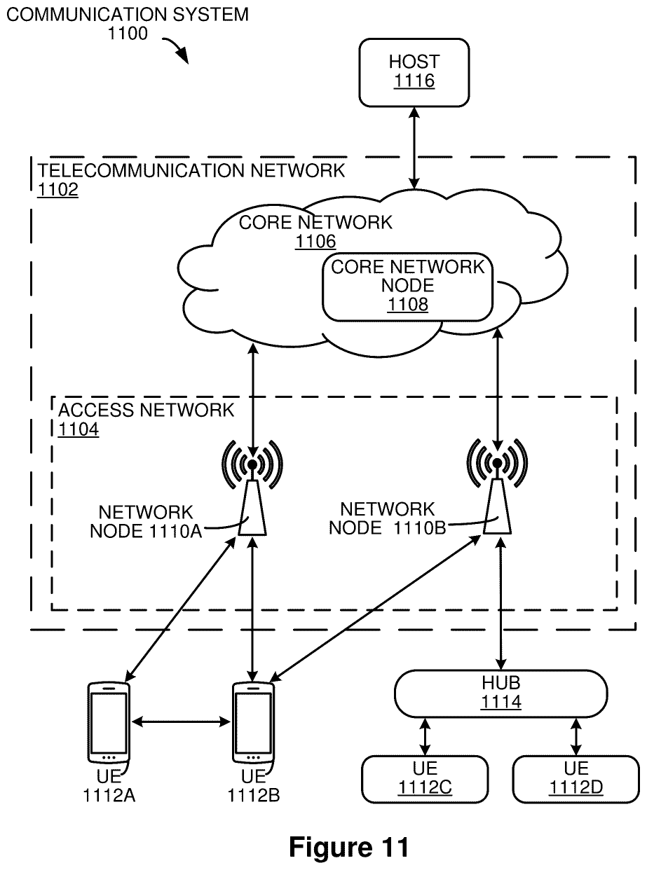

FIG. 11 shows an example of a communication system 1100 in accordance with some embodiments.

In the example, the communication system 1100 includes a telecommunication network 1102 that includes an access network 1104, such as a RAN, and a core network 1106, which includes one or more core network nodes 1108. The access network 1104 includes one or more access network nodes, such as network nodes 1110a and 1110b (one or more of which may be generally referred to as network nodes 1110), or any other similar 3GPP access node or non-3GPP access point. The network nodes 1110 facilitate direct or indirect connection of UE, such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub-that is, a hub whose primary function is to route communications to/from the UEs from/to the network node 1110b. In other embodiments, the hub 1114 may be a non-dedicated hub-that is, a device which is capable of operating to route communications between the UEs and network node 1110b, but which is additionally capable of operating as a communication start and/or end point for certain data channels.

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310.

Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

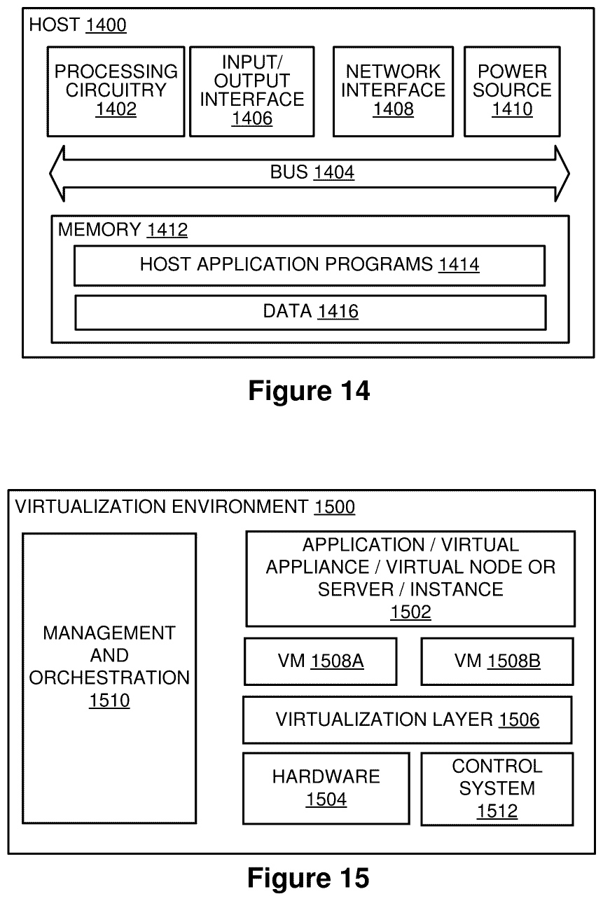

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

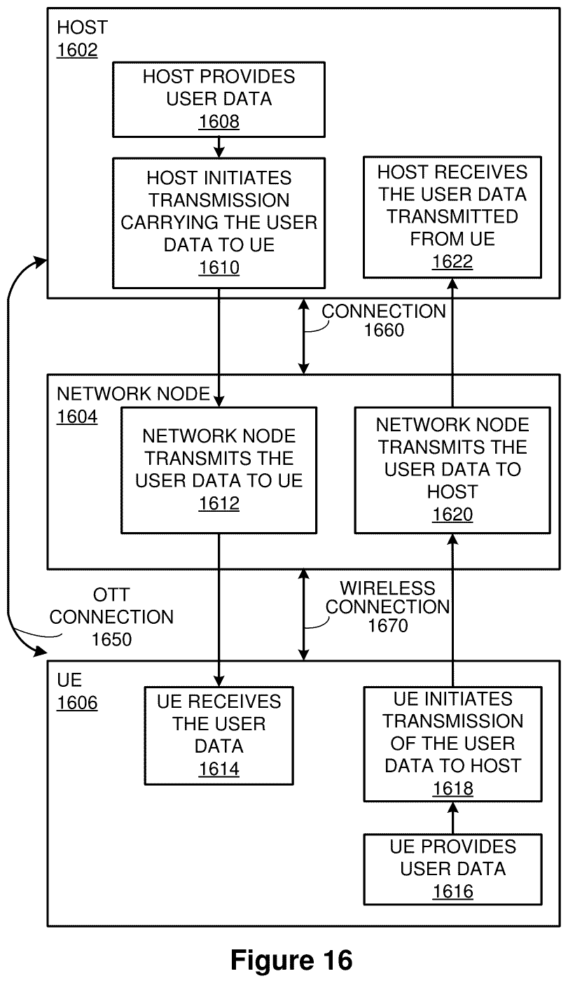

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc. ; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Further definitions and embodiments are discussed below.

In the above-description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a user equipment, UE, the method comprising:
receiving from a network node, a sounding reference signal, SRS, configuration; and
transmitting an uplink transmission towards the network node comprising a SRS across a first physical resource block, PRB, and a phase shifted SRS across at least one additional PRB wherein the transmitting the phase shifted SRS across the at least one additional PRB comprises conditionally transmitting the phase shifted SRS according to a downlink reference signal measurement.

2. The method of claim 1, wherein the configuration comprises at least one of a value for the phase shift, and a size of the at least one additional PRB.

3. The method of claim 2, wherein the size comprises at least one of: a number of PRB having the same phase shift for the SRS, a size that matches a size of the first PRB, or a first indicator that indicates the size, and wherein the value for the phase shift comprises an indicator that indicates the value.

4. The method of claim 1, wherein the receiving the SRS configuration comprises receiving a radio resource control, RRC, message.

5. The method of claim 1, wherein the transmitting the phase shifted SRS across the at least one additional PRB is triggered by the UE.

6. (canceled)

7. The method of claim 1, wherein the transmitting the phase shifted SRS across the at least one additional PRB comprises at least one of: an aperiodic transmission triggered by a downlink control information, DCI, a semi persistent transmission triggered by a medium access control, MAC, control element (CE), and a periodic transmission set in the configuration.

8. The method of claim 1, wherein the transmitting the phase shifted SRS across the at least one additional PRB is triggered by the network node.

9. The method of claim 8, wherein the triggered by the network node is triggered by a wireless channel status, or an evaluation of a speed or direction of movement of the UE.

10. A method performed by a network node, the method comprising:
transmitting to a user equipment, UE, a sounding reference signal, SRS, configuration; and
receiving from the UE a SRS transmitted across a first physical resource block, PRB, and a phase shifted SRS transmitted across at least one additional PRB, wherein the phase shifted SRS transmitted across the at least one additional PRB comprises a conditionally transmitted phase shifted SRS according to a downlink reference signal measurement.

11. The method of claim 10, wherein the configuration comprises at least one of a value for the phase shift, and a size of the at least one additional PRB.

12. The method of claim 11, wherein the size comprises at least one of: a number of PRB having the same phase shift for the SRS, a size that matches a size of the first PRB, or a first indicator that indicates the size, and wherein the value for the phase shift comprises an indicator that indicates the value.

13. The method of claim 10, wherein the transmitting (800) the SRS configuration comprises transmitting a radio resource control, RRC, message.

14. The method of claim 10, wherein the phase shifted SRS transmitted across the at least one additional PRB is triggered by the UE.

15. (canceled)

16. The method of claim 10, wherein the phase shifted SRS transmitted across the at least one additional PRB comprises at least one of: an aperiodic transmission triggered by a downlink control information, DCI, a semi persistent transmission triggered by a medium access control, MAC, control element (CE), and a periodic transmission set in the configuration.

17. The method of claim 10, wherein the phase shifted SRS transmitted across the at least one additional PRB is triggered by the network node and wherein the triggered by the network node is triggered by a wireless channel status, or an evaluation of a speed or direction of movement of the UE.

18-35. (canceled)

36. A user equipment, UE, the UE comprising:
processing circuitry
memory coupled with the processing circuitry, wherein the memory includes instructions that when executed by the processing circuitry causes the UE to perform operations comprising:
receive, from a network node, a sounding reference signal, SRS, configuration; and
transmit an uplink transmission towards the network node comprising a SRS across a first physical resource block, PRB, and a phase shifted SRS across at least one additional PRB, wherein the phase shifted SRS transmitted across the at least one additional PRB comprises a conditionally transmitted phase shifted SRS according to a downlink reference signal measurement.

37-41. (canceled)

42. A computer program product comprising a non-transitory storage medium including program code to be executed by processing circuitry of a UE, whereby execution of the program code causes the UE to perform operations comprising:
receive, from a network node, a sounding reference signal, SRS, configuration; and transmit an uplink transmission towards the network node comprising a SRS across a first physical resource block, PRB, and a phase shifted SRS across at least one additional PRB wherein the phase shifted SRS transmitted across the at least one additional PRB comprises a conditionally transmitted phase shifted SRS according to a downlink reference signal measurement, wherein the configuration comprises at least one of a value for the phase shift, and a size of the at least one additional PRB.

43. (canceled)

44. A network node the network node comprising:
processing circuitry
memory coupled with the processing circuitry, wherein the memory includes instructions that when executed by the processing circuitry causes the network node to perform operations comprising:
transmit, to a user equipment, UE, a sounding reference signal, SRS, configuration; and
receive from the UE a SRS transmitted across a first physical resource block, PRB, and a phase shifted SRS transmitted across at least one additional PRB, wherein the phase shifted SRS transmitted across the at least one additional PRB comprises a conditionally transmitted phase shifted SRS according to a downlink reference signal measurement.

45-67. (canceled)
